(19) United States
(12) Patent Application Publication
(10) Pub. No.: US 2024/0270977 A1
(43) Pub. Date: Aug. 15, 2024

(54) MULTI-COMPONENT POWDER COATING COMPOSITIONS AND METHODS FOR HEAT SENSITIVE SUBSTRATES

(71) Applicant: PPG Industries Ohio, Inc., Cleveland, OH (US)

(72) Inventors: Brian C. McBean, Amherst, OH (US); Jeno Muthiah, Wayne, IL (US)

(73) Assignee: PPG Industries Ohio, Inc., Cleveland, OH (US)

(21) Appl. No.: 18/569,622

(22) PCT Filed: Jun. 16, 2022
(86) PCT No.: PCT/US2022/072970

§ 371 Date: Dec. 13, 2023

Related U.S. Application Data
(60) Provisional application No. 63/237,159, filed on Aug. 26, 2021.
(60) Provisional application No. 63/202,635, filed on Jun. 18, 2021.

(51) Int. Cl. C09D 5/03; C09D 7/42; C09D 7/65; C09D 163/00

(52) U.S. Cl. CPC C09D 5/035; C09D 7/42; C09D 7/65; C09D 163/00

(57) ABSTRACT

Coated substrates and methods may comprise multiple components forming a coating composition. Each component may independently comprise a film forming resin, a crosslinker, a catalyst, and/or a matting agent. The multi-component coating composition may cure at low temperatures and may alter the gloss value of the cured coating.

### CROSS-REFERENCES TO RELATED APPLICATIONS

This application claims priority to U.S. Provisional Patent Application No. 63/202,635, filed Jun. 18, 2021, and U.S. Provisional Patent Application No. 63/237,159, filed Aug. 26, 2021, both of which are incorporated herein by reference in their entireties for all purposes.

### FIELD

The present disclosure relates to multi-component powder coating compositions for heat sensitive substrates, and methods for making and using the same.

### BACKGROUND

Powder coatings are applied to substrates in order to provide numerous properties including protective and decorative properties. Powder coatings typically comprise an extruded thermoplastic or thermoset polymer which is then ground or milled into a powder. The powder is then typically electrostatically applied to a substrate, and then cured with heat or UV radiation to form a coating layer. Powder coatings are often cured at temperatures of around 200° C. for around 10-15 minutes, depending on the coating and substrate. However, some substrates (e.g. wood, polymers) have a sensitivity to heat and may warp, melt, or degrade when exposed to high temperatures. Additionally, many coating compositions often are only configured to provide one type of finish (matte, glossy, etc.), and achieving certain finishes often also requires high temperatures.

What is needed is an improvement over the foregoing.

### SUMMARY

The present disclosure provides powder coating compositions and methods comprising multi-component coating compositions. Each component of the powder coating composition may independently comprise at least one of a film forming resin, a crosslinker, a catalyst, and a matting agent. The powder coating compositions may be cured at relatively low temperatures (e.g. less than 200° C.). Furthermore, the curing conditions and powder composition may be altered to vary the gloss value of the cured coating.

The present disclosure provides a powder coating system, including a first component (A) including a first film forming resin and a crosslinker, and a second component (B) including a second film forming resin and a matting agent, wherein at least one of the components (A) and (B) additionally comprises a catalyst present in an amount of at least 3 wt. % based on the total weight of the respective component.

The present disclosure also provides a method of coating a substrate including contacting a first component (A) with a second component (B) to form a coating, wherein component (A) comprises a first film forming resin and a crosslinker, and component (B) comprises a second film forming resin and a matting agent; applying the coating to a substrate; and heating the coating on the substrate at a temperature of less than 130° C. (266° F.) for less than 10 minutes to form a cured coating.

The present disclosure further provides a powder coating system including a first component (A) including a first film forming resin and a crosslinker; and a second component (B) including a second film forming resin and a matting agent; wherein the second film forming resin is present in an amount greater than 4 wt. % based on the total weight of the powder coating system.

### DESCRIPTION OF THE DRAWINGS

FIG. 1 is a flow diagram for a method of coating a substrate.

### DETAILED DESCRIPTION

The present disclosure provides multi-component powder coating compositions including a matting agent and methods of using the compositions, making the compositions, and/or applying the compositions to a substrate. The coating compositions may also comprise a film forming resin, and a cross linker. The gloss value of the cured coating compositions may be altered by varying curing conditions and/or by varying the components within the coating compositions. Substrates may be coated by contacting at least a portion of the substrate with the multi-component coating composition and curing the composition to form a coating layer. Curing may be carried out at a low temperature.

### I. Definitions.

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for coating thicknesses, weight percentages of components, or amounts of components added should be construed as being modified by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

“Polymer” refers to oligomers, homopolymers (e.g. prepared form a single monomer species), copolymers (e.g. prepared form at least two monomer species), terpolymers (e.g. prepared from at least three monomer species), and graft polymers.

“Matting agent” refers to any compound or mixture of compounds configured to decrease the gloss value of the coating composition when cured in comparison to the same coating without the matting agent.

“Film forming resin” refers to a resin that may form a self-supporting continuous film on at least a horizontal surface of a substrate upon removal or any diluents or carriers present in the composition and/or upon curing. The term “resin” is used here interchangeably with “polymer”.

“Catalyst” refers to a material that increases the rate of reaction of one or more reactive components.

“Crosslinker” refers to a molecule comprising two or more functional groups that are reactive with other functional groups and that is capable of linking two or more monomers or polymers through chemical bonds.

### II. Substrates

The present disclosure relates to contacting at least a portion of a substrate with multi-component powder coating composition and curing the composition to form a coating layer.

The substrate according to the present disclosure can be selected from a wide variety of substrates and combinations thereof. Non-limiting examples of substrates include vehicles and automotive substrates, industrial substrates, marine substrates and components such as ships, vessels, and on-shore and off-shore installations, storage tanks, packaging substrates, aerospace components, wood flooring and furniture, fasteners, coiled metals, heat exchangers, vents, an extrusion, roofing, wheels, grates, belts, conveyors, grain or seed silos, wire mesh, bolts or nuts, a screen or grid, HVAC equipment, frames, tanks cords, wires, apparel, electronic components, including housings and circuit boards, glass, sports equipment, including golf balls, stadiums, buildings, bridges, containers such as a food and beverage containers, and the like. As used herein, “vehicle” or variations thereof includes, but is not limited to, civilian, commercial and military aircraft, and/or land vehicles such as airplanes, helicopters, cars, motorcycles, and/or trucks. The shape of the substrate can be in the form of a sheet, plate, bar, rod or any shape desired.

The substrates, including any of the substrates previously described, can be metallic or non-metallic. Metallic substrates include, but are not limited to, tin, steel, cold rolled steel, hot rolled steel, steel coated with zinc metal, zinc compounds, zinc alloys, electrogalvanized steel, hot-dipped galvanized steel, galvanealed steel, galvalume, steel plated with zinc alloy, stainless steel, zinc-aluminum magnesium alloy coated steel, zinc-aluminum alloys, aluminum, aluminum alloys, aluminum plated steel, aluminum alloy plated steel, steel coated with a zinc-aluminum alloy, magnesium, magnesium alloys, nickel, nickel plating, bronze, tinplate, clad, titanium, brass, copper, silver, gold, 3-D printed metals, cast or forged metals and alloys, or combinations thereof.

Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, engineering polymers such as poly(etheretherketone) (PEEK), polycarbonate acrylobutadiene styrene (PC/ABS), polyamide, wood, veneer, wood composite, particle board, medium density fiberboard, cement, stone, glass, paper, cardboard, textiles, leather both synthetic and natural, composite substrates such as fiberglass composites or carbon fiber composites, 3-D printed polymers and composites, and the like.

### III. Optional Surface Coating

The substrate may be coated with an optional surface coating before the application of the powder coating composition, and the powder coating composition may contact the surface coating. The surface coating may improve coverage or adhesion of the powder coating composition on the substrate. The surface coating may also be referred to as a “first material” as well as a “primer” or a “priming coating”. In embodiments in which the substrate is coated with a surface coating before application of the coating composition, the coating composition may be referred to as an overcoat. The coating composition itself, or the coating composition in combination with a surface coating, a substrate, and/or any additional coating compositions or layers may be referred to as a coating system.

The surface coating may be selected to interact with the coating composition and/or the substrate. As used herein, the term “interact” and variants thereof refer to the ability of the surface coating to effect or influence any aspect of the coating composition and/or substrate including, for example, its cure, physical/chemical properties, performance, appearance, and the like, and also encompasses chemical bonding. The surface coating may comprise a catalyst that catalyzes the curing of the coating composition, a component that is reactive with at least one component of the coating composition, and/or a rheology modifier that affects the flow of the overcoat over the substrate.

As used herein, a “catalyst” refers to a material that increases the rate of reaction of one or more reactive components. Thus, the surface coating may comprise a catalyst that increases the rate of reaction of the film-forming resin(s) and optional crosslinker(s) that form a binder to thereby catalyze cure of the overcoat. The catalyst used as all or part of the surface coating may therefore be selected based on the components used in the overcoat.

The surface coating may comprise a component that is reactive with at least one component of the overcoat. For example, the surface coating may comprise a component that is reactive with a film-forming resin(s) and/or crosslinker(s) used in the overcoat and/or a binder in the overcoat. Non-limiting examples of such reactive components include a crosslinker, a resin such as a film-forming resin, a reactive diluent, a monomer, or any combination thereof.

It is appreciated that the functionality and types of crosslinkers, resins, reactive diluents, and monomers used in the surface coating are selected to react with the functionality of one or more components of the overcoat. For example, as discussed further below, the overcoat may comprise a hydroxyl functional film-forming resin and the surface coating may comprise a crosslinker reactive with the hydroxyl functionality such as, for example, an oxazoline functional crosslinker, a polycarbodiimide functional crosslinker, an isocyanate or blocked isocyanate functional crosslinker, an aminoplast crosslinker, or any combination thereof. Other non-limiting examples include overcoats that comprise a carboxylic acid functional film-forming resin and surface coating that comprise an epoxy crosslinker, a beta-hydroxyalkylamide crosslinker, a hydroxyalkylurea crosslinker, and/or glycoluril.

The surface coating, which may comprise a catalyst, reactive component, and/or rheology modifier, may be in solid or liquid form. The surface coating may also be dispersed or dissolved in an aqueous or non-aqueous liquid medium. The dispersions and solutions may comprise additional components including, but not limited to, surfactants and surfactant solubilizers. It is further appreciated that the powder coating composition may also include a catalyst, reactive component such as a crosslinker, and/or rheology modifier that is different than the catalyst, reactive component, and/or rheology modifier of the surface coating.

As used herein, a “non-aqueous medium” refers to a liquid medium comprising less than 50 weight % water, based on the total weight of the liquid medium. Such non-aqueous liquid mediums may comprise less than 40 weight % water, or less than 30 weight % water, or less than 20 weight % water, or less than 10 weight % water, or less than 5% water, based on the total weight of the liquid medium. The solvents that make up 50 weight % or more of the liquid medium include organic solvents. Non-limiting examples of suitable organic solvents include polar organic solvents e.g. protic organic solvents such as glycols, glycol ether alcohols, alcohols; and ketones, glycol diethers, esters, and diesters. Other non-limiting examples of organic solvents include aromatic and aliphatic hydrocarbons.

### IV. Powder Coating Compositions

Powder coating compositions as described herein generally comprise a film forming resin, a crosslinker, and a matting agent. Each of these compounds may be separated into different components of the coating composition. The coating compositions may comprise a powder overcoat which, as used herein, refers to an overcoat embodied in solid particulate form. The coating compositions used herein generally comprise powder coatings but may be referred to simply as “coating compositions” or “coatings” for simplicity. The coating composition may also comprise a liquid overcoat, which may be formed by melting or otherwise liquidizing a powder overcoat. The coating compositions may be cured to form a coating layer on the substrate. Multiple layers of coating compositions may be used to form multi-layer coatings.

The coating compositions generally comprise multiple components, for example a component “A” and a component “B” which are mixed to form the coating composition. The coating compositions may have two or more components. The mixing may occur when each component is a solid or a powder, and the components may not react with one another upon solid mixing. Upon curing, the components may melt and mix together as liquids, which may initiate crosslinking and curing of the coating composition to form a cured coating layer. The coating composition may also be stored for an indeterminate amount of time so long as the softening or glass transition temperature (Tg) is not reached, as discussed below.

Each component independently may comprise a film forming resin, a crosslinker, a catalyst, a matting agent, and other additives (e.g. flow agents, colorants, stabilizers, degassing agents, antioxidants, hardening agents, waxes, etc.). For example, component A may comprise a first film forming resin and a matting agent, component B may comprise a second film forming resin and a crosslinker, and each of the components A and B may independently comprise a catalyst and other additives. The labels “A” and “B” are not meant to impart any ordering or priority of components but are simply used to distinguish various components. Any compounds or additives disclosed as being present in component “A” may additionally or alternatively be present in component “B” and vice versa. Any compound loadings, weight percentages, or ratios as described herein may be relative to the individual component in which the compound is initially found, or relative to the coating composition as a whole.

The components of the coating composition may be present in any ratio. For example, the components A and B may be present in a weight ratio of X:Y respectively, wherein X and Y may each independently be 0.5, 0.75, 1, 1.25, 1.5, 1.75, 2, 2.25, 2.5, 2.75, 3, 3.25, 3.5, 3.75, 4, 4.5, or 5, or any range including any two of these values as endpoints. For example, the ratio of component A to B may be from 1:3 to 3:1, from 2:5 to 5:2, from 1:2 to 2:1, from 2:3 to 3:2, or from 4:5 to 5:4.

The coating compositions herein may comprise a binder or a film forming resin in one or multiple components. Further, a “binder” refers to a constituent material that may hold all coating composition components together upon curing. The binder may comprise one or more film-forming resins that may be used to form the coating layer. As used herein, a “film-forming resin” refers to a resin that may form a self-supporting continuous film on at least a horizontal surface of a substrate upon removal or any diluents or carriers present in the composition and/or upon curing. The term “resin” is used here interchangeably with “polymer”. Film forming resins may be incorporated into components of the powder coating compositions as a liquid or as a solid.

The coating composition used with the present disclosure may include any variety of thermosetting powder compositions as known in the art. As used herein, the term “thermosetting” refers to compositions that “set” irreversibly upon curing or crosslinking, wherein polymer chains of polymeric components are joined together by covalent bonds. This property is usually associated with a cross-linking reaction of the composition constituents often induced, for example, by heat or radiation. Once cured, a thermosetting resin will not melt upon the application of heat and is insoluble in solvents. The coating compositions used with the present disclosure may also include thermoplastic powder compositions. As used herein, “thermoplastic” refers to compositions that include polymeric components that are not joined by covalent bonds and, thereby, can undergo liquid flow upon heating.

Non-limiting examples of suitable film-forming resins include (meth)acrylate resins, polyurethanes, polyesters, polyamides, polyethers, polysiloxanes, epoxy resins, vinyl resins, copolymers thereof, and combinations thereof. As used herein, “(meth)acrylate” and like terms refers both to the acrylate and the corresponding methacrylate. Further, the film-forming resins may have any of a variety of functional groups including, but not limited to, carboxylic acid groups, amine groups, epoxide groups, hydroxyl groups, thiol groups, carbamate groups, amide groups, urea groups, isocyanate groups (including blocked isocyanate groups), and combinations thereof.

The coating compositions may comprise any number of film forming resins, for example one film forming resin, or two or more film forming resins. Any particular film forming resin or any combination of form filming resins may be present in the coating composition in an amount of at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %, at least 80 wt. %, at least 85 wt. %, at least 90 wt. %, or any range including any two of these values as endpoints based on the total weight of the coating composition or based on the weight of one component of the coating composition. For example, any particular film forming resin or combination of film forming resins may be present in the coating composition from 1 wt. % to 90 wt. %, from 4 wt. % to 90 wt. %, from 4 wt. % to 80 wt. %, from 4 wt. % to 70 wt. %, from 4 wt. % to 60 wt. %, from 4 wt. % to 50 wt. %, from 4 wt. % to 40 wt. %, from 4 wt. % to 30 wt. %, from 4 wt. % to 25 wt. %, from 4 wt. % to 20 wt. %, from 4 wt. % to 15 wt. %, from 4 wt. % to 10 wt. %, from 10 wt. % to 70 wt. %, from 20 wt. % to 70 wt. %, from 30 wt. % to 70 wt. %, from 30 wt. % to 60 wt. %, or from 20 wt. % to 50 wt. % based on the total weight of the coating composition or based on the weight of one component of the coating composition.

In some embodiments, different components of the coating composition comprise different film forming resins. For example, component A may comprise a first film forming resin, and component B may comprise a second, different film forming resin. Additionally, either component may comprise a film forming resin that is not present in the other component. For example, component A may comprise a solid resin and a liquid resin, and component B may comprise only a solid resin.

Coating compositions may comprise a crosslinker in one or multiple components that may be selected from any of the crosslinkers known in the art to react with the functionality of one or more film-forming resins used in the coating composition. As used herein, the term “crosslinker” refers to a molecule comprising two or more functional groups that are reactive with other functional groups and that is capable of linking two or more monomers or polymers through chemical bonds. Alternatively, the film-forming resins that form the binder of the coating composition may have functional groups that are reactive with themselves; in this manner, such resins are self-crosslinking.

Non-limiting examples of crosslinkers include phenolic resins, amino resins, epoxy resins, triglycidyl isocyanurate, beta-hydroxy (alkyl) amides, alkylated carbamates, (meth)acrylates, isocyanates, blocked isocyanates, polyacids, anhydrides, organometallic acid-functional materials, polyamines, polyamides, aminoplasts, carbodiimides, oxazolines, and combinations thereof.

Any particular crosslinker or any combination of crosslinkers may be present in the coating composition in an amount of at least 0.1 wt. %, at least 0.5 wt. %, at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 15 wt. %, at least 20 wt. %, at least 25 wt. %, or any range including any two of these values as endpoints based on the total weight of the coating composition or based on the weight of one component of the coating composition. For example, any crosslinker or combination of crosslinkers may be present in an amount from 0.5 wt. % to 10 wt. %, from 0.5 wt. % to 8 wt. %, from 0.5 wt. % to 6 wt. %, from 0.5 wt. % to 5 wt. %, from 1 wt. % to 5 wt. %, from 1 wt. % to 4 wt. %, or from 1 wt. % to 2 wt. % based on the total weight of the coating composition or based on the weight of one component of the coating composition.

The coating composition may comprise a matting agent in one or multiple components. As used herein, a “matting agent” refers to any compound or mixture of compounds configured to decrease the gloss value of the coating composition when cured in comparison to the same coating without the matting agent.

In general, matting agents may operate to decrease the gloss value of the coating by one or both two mechanisms. In a first mechanism, the matting agent is in the form of a wax or wax-like substance that does not react with the binder/film-forming system but rather migrates, flows, or concentrates toward the surface of the coating upon cure to decrease the gloss. In a second mechanism, the matting agent, as described herein, includes functional groups, such as acid groups, which are reactive with the binder/film-forming system to create chemical disruption in the binder/film forming system to decrease the gloss.

Non-limiting examples of matting agents include acrylic resins, glycidyl methacrylate (GMA) acrylic resins, amino mono salts, polycarboxylic acids, and styrene maleic anhydride copolymers. Further, as set forth above, the matting agents may have any of a variety of functional groups including, but not limited to, acid groups, carboxylic acid groups, amine groups, epoxide groups, hydroxyl groups, thiol groups, carbamate groups, amide groups, urea groups, isocyanate groups (including blocked isocyanate groups), and combinations thereof. One example of a functionalized matting agent is an acid or carboxyl-functional acrylic resin. The functional groups on the matting agent may be configured to react or otherwise interact with the film forming resin or other components within the coating composition.

The matting agent may be in a solid form, such as a powder or particulate form.

The film forming resin and/or the matting agent may have a softening or melt temperature that allows for the coating composition to cure at lower temperatures. For example, the film forming resin and/or matting agent may have a softening temperature of less than 175° C., less than 150° C., less than 140° C., less than 130° C., less than 125° C., less than 120° C., less than 115° C., less than 110° C., less than 100° C., less than 95° C., less than 90° C., less than 85° C., less than 80° C., less than 75° C., less than 70° C., less than 65° C., less than 60° C., or any range including any two of these values as endpoints. For example, the film forming resin and/or matting agent may have a softening temperature from 65° C. to 130° C., from 65° C. to 100° C., from 65° C. to 90° C., from 65° C. to 85° C., from 65° C. to 80° C., from 70° C. to 85° C., from 75° C. to 85° C., from 100° C. to 140° C., from 110° C. to 140° C., from 110° C. to 120° C., from 110° C. to 130° C., or from 115° C. to 130° C. In some embodiments, the film forming resin has a lower softening temperature or glass transition temperature (Tg) than the matting agent. Stated otherwise, the matting agent may have a higher softening temperature or glass transition temperature (Tg) than the form forming resin.

Any matting agent or any combination of matting agents may be present in the coating composition in an amount of at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, or any range including any two of these values as endpoints based on the total weight of the coating composition or based on the weight of one component of the coating composition. For example, the matting agent may be present in the coating composition in an amount from 1 wt. % to 60 wt. %, from 1 wt. % to 50 wt. %, from 1 wt. % to 40 wt. %, from 5 wt. % to 40 wt. %, from 10 wt. % to 40 wt. %, from 10 wt. % to 30 wt. %, from 10 wt. % to 20 wt. %, from 10 wt. % to 15 wt. %, from 10 wt. % to 50 wt. %, from 20 wt. % to 50 wt. %, from 25 wt. % to 50 wt. %, from 25 wt. % to 40 wt. %, or from 25 wt. % to 35 wt. %.

The coating composition may also comprise a catalyst in one or multiple components. The catalyst may also be referred to as a “cure catalyst” which cures the firm-forming reactions between the epoxy, acrylic, and crosslinking components discussed below, for example. Suitable catalysts may be any known in the art. Non-limiting examples of a catalyst include: tertiary amines, such as diazabicyclo[2.2.2]octane and 1,5-diazabicyclo[4.3.0]non-5-ene, 1-ethyl-3-phospholine, 1-ethyl-3-methyl-3-phospholine-1-oxide, 1-ethyl-3-methyl-3-phospholine-1-sulfide, 1-ethyl-3-methyl-phospholidine, 1-ethyl-3-methyl-phospholidine-1-oxide, 3-methyl-1-phenyl-3-phospholine-1-oxide and bicyclic terpene alkyl or hydrocarbyl aryl phosphine oxide or camphene phenyl phosphine oxide, phospholines, bisphenol A, bisphenol A diglycidyl ether, bisphenol F, imidazole, or any derivatives or combinations thereof. Other examples of catalysts include an imidazole, a substituted imidazole, or adducts of an imidazole or substituted imidazole and an epoxy resin or quaternary ammonium salts thereof, and mixtures of any of the aforesaid materials, including, for example, a substituted imidazole of 2-methylimidazole is used. Another suitable substituted imidazole is 2-phenylimidazole.

Any particular catalyst or any combination of catalysts may be present in the coating composition in an amount of at least 0.1 wt. %, at least 0.5 wt. %, at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 15 wt. %, at least 20 wt. %, at least 25 wt. %, at least 30 wt. %, or any range including any two of these values as endpoints based on the total weight of the coating composition or based on the weight of one component of the coating composition. For example, any catalyst or combination of catalysts may be present in the coating composition in an amount from 0.1 wt. % to 30 wt. %, from 1 wt. % to 20 wt. %, from 3 wt. % to 20 wt. %, from 3 wt. % to 15 wt. %, from 3 wt. % to 10 wt. %, from 3 wt. % to 9 wt. %, from 3 wt. % to 8 wt. %, from 3 wt. % to 7 wt. %, from 3 wt. % to 6 wt. %, from 3 wt. % to 5 wt. %, or from 4 wt. % to 8 wt. %, based on the total weight of the coting composition or based on the weight of one component of the coating composition. The coating composition may also be substantially free, essentially free, or completely free of any of the previously described film-forming resins and/or crosslinkers. For example, the coating composition may be substantially free, essentially free, or completely free of a hydroxyl functional film-forming resin and/or an isocyanate functional crosslinker. The term “substantially free” as used in this context means the overcoat contains less than 1000 parts per million (ppm), “essentially free” means less than 100 ppm, and “completely free” means less than 20 parts per billion (ppb) of a certain film-forming resin and/or crosslinker such as a hydroxyl functional film forming resin and/or an isocyanate functional crosslinker, based on the total weight of the coating composition.

The coating composition may also include other optional materials in one or multiple components. For example, the overcoat may also comprise a colorant. As used herein, “colorant” refers to any substance that imparts color and/or other opacity and/or other visual effect to the composition. The colorant may be added to the coating in any suitable form, such as discrete particles, dispersions, solutions, and/or flakes. A single colorant or a mixture of two or more colorants may be used in the coatings of the present disclosure.

Example colorants include pigments (organic or inorganic), dyes and tints, such as those used in the paint industry and/or listed in the Dry Color Manufacturers Association (DCMA), as well as special effect compositions. A colorant may include, for example, a finely divided solid powder that is insoluble, but wettable, under the conditions of use. A colorant may be organic or inorganic and may be agglomerated or non-agglomerated. Colorants may be incorporated into the coatings for example by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof.

Example dyes include, but are not limited to, those that are solvent and/or aqueous based such as phthalo green or blue, iron oxide, bismuth vanadate, anthraquinone, and peryleneand quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions Division of Eastman Chemical, Inc.

Other non-limiting examples of components that may be used with the coating composition in one or multiple components of the present disclosure include plasticizers, abrasion resistant particles, fillers including, but not limited to, micas, talc, clays, and inorganic minerals, metal oxides, metal flake, various forms of carbon, anti-oxidants, hindered amine light stabilizers, UV light absorbers and stabilizers, surfactants, flow and surface control agents, waxes, thixotropic agents, catalysts, reaction inhibitors, corrosion-inhibitors, and other customary auxiliaries. As used herein, matting agents may be contemplated as a separate compound with separate functionality compared to other additives that may be present in the coating composition.

As used herein, matting agents and flow agents are contemplated as separate compounds with separate functionality. Matting agents are configured to reduce the gloss value of the cured powder coating composition, and flow agents are configured to reduce the surface tension of the formed film and/or alter the flow properties (e.g. viscosity) of the coating compositions in order to reduce or eliminate film defects such as craters. Typical flow agents include polyacrylates which, in powder coatings, are typically dispersed on a silica carrier.

After being applied over the substrate to which the surface coating is applied, the coating composition may be physisorbed onto the substrate. As used herein, “physisorbed”, “physisorption”, and like terms refers to a physical adsorption of a composition or material over the substrate in which the forces involved are intermolecular forces. Alternatively, the coating composition may be chemisorbed onto the substrate. As used herein, “chemisorbed”, “chemisorption”, and like terms refers to a chemical adsorption of a composition or material over the substrate in which chemical or ionic bonds are formed.

The present coating composition may be a topcoat, i.e., an exterior-most or exteriorly exposed coating, which either may be applied directly to the outer surface of the substrate article or alternatively, may be applied over one or more underlying coatings, or undercoats. For example, one undercoat may be a surface coating, which is applied directly to the outer surface of the substrate article, with the present coating composition applied over the surface coating. The present coating composition may also form part of a coating system which includes a primer together with a midcoat applied over the surface coating, with the present coating composition applied over the midcoat. Further, the surface coating layer may include one or more distinct, separately-applied layers, and the midcoat may also include one or more distinct, separately-applied layers.

The coating composition of the present disclosure may have any suitable average particle size (D₅₀). The coating composition may have an average particle size from 5 to 300 microns (μm), suitably from 5 to 150 μm, such as from 10 to 75 μm, or even from 10 to 50 μm. Particles having these sizes may be produced by any suitable method. Suitable methods will be well known to a person skilled in the art. Examples of suitable methods include, but are not limited to, cold grinding and sieving methods.

The average particle size (D₅₀) may be measured by any suitable method. Suitable methods will be well known to a person skilled in the art. The average particle size (D₅₀) may be measured using laser diffraction analysis. Suitably, the laser diffraction analysis may be performed using a Microtrac S3000 laser diffraction analyser (commercially available from Microtrac), suitably according to the manufacturer's protocol.

The coating composition of the present invention may be prepared by any suitable method. For example, one component (e.g. component A) of the coating composition may be prepared by dry blending any compounds/components to be used in the component (e.g. film forming resin, crosslinker, matting agent, catalyst, and/or other additives) in a blender. Another component (e.g. component B) may be prepared by dry blending any compounds/components to be used in the component (e.g. film forming resin, crosslinker, matting agent, catalyst, and/or other additives) in a blender. The blender may be operated for any suitable period of time. Suitably, the blender may be operated for a period of time sufficient to result in a homogeneous dry blend of the materials charged thereto. The homogenous dry blend of each component may then be independently melt blended in an extruder, such as a twin-screw co-rotating extruder, operated within a temperature range from 80 to 140° C. The extrudate may be cooled and milled to an average particle size as described above, and each of the components may be mixed once milled.

### V. Coating Methods

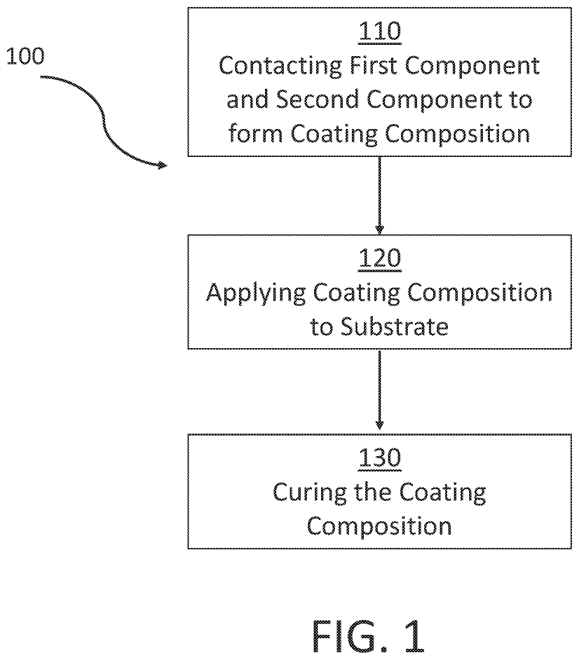

As shown in FIG. 1, a method 100 for coating a substrate is shown. The method 100 comprises a contacting step 110, an applying step 120, and a curing step 130. Contacting step 110 comprising contacting at least a first component and a second component to form a coating composition. The first component and second component may be contacted through mixing, grinding, or any suitable contacting method. The components may be a solid and more specifically may be a powder with an average particle size. More than two components may be contacted. Each component may have different compounds within them, and they may also have similar or the same components. The components may be contacted in any suitable ratio to form a coating composition.

When the components of the coating composition are contacted/combined by extrusion, the extrusion may optionally be conducted at an elevated temperature above 200° F. (90° C.), yet less than the softening or glass transition temperature (Tg) of the coating. For example, the extrusion may be carried out at a temperature from 200° F. to 230° F., from 210° F. to 220° F., for example. Stated differently such temperature may be from 90° C. to 110° C. or from 100° C. to 105° C., for example.

Applying step 120 comprises applying the coating composition to a substrate, such as via electrostatic spraying. Coating methods will be described in more detail herein. The substrate may be preheated to a surface temperature or a bulk temperature before applying step 120. For example, the substrate may be heated to a surface temperature of at least 100° F., at least 125° F., at least 150° F., at least 175° F., at least 200° F., at least 225° F., at least 250° F., at least 275° F., at least 300° F., at least 325° F., or any range including any two of these values as endpoints. Stated differently, the substrate may be heated to a surface temperature of at least 40° C., at least 50° C., at least 60° C., at least 70° C., at least 80° C., at least 90° C., at least 100° C., at least 110° C., at least 120° C., at least 130° C., at least 140° C., at least 150° C., or any range including any two of these values as endpoints. For example, the substrate may be heated to a surface temperature from 40° C. to 150° C., from 50° C. to 150° C., from 60° C. to 150° C., from 70° C. to 150° C., from 80° C. to 150° C., from 90° C. to 150° C., from 100° C. to 150° C., from 110° C. to 150° C., from 110° C. to 140° C., or from 120° C. to 140° C.

Once the coating composition has been applied to the substrate, the coating is cured during curing step 130. The curable coating composition may be cured with heat, increased or reduced pressure, chemically such as with moisture, or with other means such as actinic radiation, and combinations thereof. For example, curing may comprise an initial curing step with radiation, followed by heating. The term “actinic radiation” refers to electromagnetic radiation that can initiate chemical reactions. Actinic radiation includes, but is not limited to, visible light, ultraviolet (UV) light, infrared (IR), X-ray, and gamma radiation.

The coating composition may be cured at a low temperature. For example, the coating composition may be cured at less than 400° F., less than 375° F., less than 350° F., less than 325° F., less than 300° F., less than 290° F., less than 280° F., less than 275° F., less than 270° F., less than 260° F. , less than 250° F., or any range including any two of these values as endpoints. Stated differently, the coating composition may be cured at less than 200° C., less than 190° C., less than 180° C., less than 170° C., less than 160° C., less than 150° C., less than 140° C., less than 130° C., less than 120° C., or any range including any two of these values as endpoints. For example, the coating composition may be cured at a temperature from 120° C. to 200° C., from 120° C. to 190° C., from 120° C. to 180° C., from 120° C. to 170° C., from 120° C. to 160° C., from 120° C. to 150° C., from 120° C. to 140° C., or from 120° C. to 130° C.

Curing step 130 may be carried out for any suitable time to allow the coating to fully or at least partially cure. The curing time may vary depending on the substrate, the coating composition, the coating thickness, ambient conditions, curing methods, or any combination of these factors. Curing time may be at least 1 minute, at least 2 minutes, at least 3 minutes, at least 4 minutes, at least 5 minutes, at least 6 minutes, at least 7 minutes, at least 8 minutes, at least 9 minutes, at least 10 minutes, at least 11 minutes, at least 12 minutes, at least 13 minutes, at least 14 minutes, at least 15 minutes, at least 20 minutes, at least 30 minutes, or any range including any two of these values as endpoints. For example, the curing time may be from 1 minute to 30 minutes, from 1 minute to 20 minutes, from 1 minute to 15 minutes, from 1 minute to 10 minutes, from 1 minute to 6 minutes, from 5 minutes to 15 minutes, from 5 minutes to 10 minutes, or from 3 minutes to 9 minutes.

The curing may also be carried out by altering the curing conditions at a particular rate. For example, the temperature, pressure, and/or radiation intensity may be increased or decreased at any suitable rate during curing. Curing step 130 may include increasing or decreasing the temperature from a temperature X to a temperature Y, wherein X and Y are not the same and may independently be 400° F., 375° F., 350° F., 325° F., 300° F., 275° F., 250° F., or any range including any two of these values as endpoints. Stated differently, X and Y may independently be 200° C., 190° C., 180° C., 170° C., 160° C., 150° C., 140° C., 130° C., 120° C., 110° C., 100° C., or any range including any two of these values as endpoints. For example, X and Y may independently be from 100° C. to 200° C., from 120° C. to 200° C., from 120° C. to 190° C., from 120° C. to 180° C., from 120° C. to 170° C., from 120° C. to 160° C., from 120° C. to 150° C., from 120° C. to 140° C., or from 120° C. to 130° C.

The curing conditions (e.g. temperature) may be altered over a period of time T, wherein T may be less than 10 minutes, less than 9 minutes, less than 8 minutes, less than 7 minutes, less than 6 minutes, less than 5 minutes, less than 4 minutes, less than 3 minutes, less than 2 minutes, less than 1 minute, less than 45 seconds, less than 30 seconds, less than 25 seconds, less than 10 seconds, or any range including any two of these values as endpoints. For example, the period of time, T, may be from 10 seconds to 10 minutes, from 30 seconds to 10 minutes, from 30 seconds to 9 minutes, from 30 seconds to 8 minutes, from 30 seconds to 7 minutes, from 30 seconds to 6 minutes, from 30 seconds to 5 minutes, from 30 seconds to 4 minutes, from 30 seconds to 3 minutes, from 30 seconds to 2 minutes, from 30 seconds to 1 minute, from 1 minute to 10 minutes, from 1 minute to 5 minutes, from 3 minutes to 9 minutes, or from 5 minutes to 10 minutes.

The change in curing conditions may also be referred to as a rate, for example change in temperature per unit time (e.g. ° C./min). The rate may be calculated by dividing the total temperature change (the difference between any X and any Y above) by the total time used to change the temperature (any time T above). The rate may be at least 1° C./min, at least 5 ° C./min, at least 10° C./min, at least 15° C./min, at least 20° C./min, at least 30° C./min, at least 40° C./min, at least 50° C./min, at least 60° C./min, at least 70° C./min, at least 75° C./min, or any range including any two of these values as endpoints. For example, the rate may be from 1° C./min to 75° C./min, from 1° C./min to 60° C./min, from 1° C./min to 50° C./min, from 1° C./min to 50° C./min, from 1° C./min to 40° C./min, from 1° C./min to 30° C./min, from 1° C./min to 20° C./min, from 1° C./min to 10° C./min, or from 1° C./min to 5° C./min. Increasing the temperature over a short period of time may result in reduced gloss values for the cured coatings.

The curing conditions (e.g. methods, time, etc.) may alter the gloss conditions of the coating composition and the cured coating layer. For example, increased curing temperatures may decrease gloss values.

In embodiments where the substrate is coated with a surface coating or undercoat before applying the coating composition, the surface coating may be applied directly to the substrate without any intermediate layers between the surface coating and the substrate. Any references to coating methods, pretreatment, priming, etc. disclosed in reference to the coating compositions may also be applied to surface coatings. For example, the coating compositions may be applied directly to a substrate, and surface coatings may also be applied directly to the substrate (in which case, the coating composition may be applied to the surface coating). The coating composition may be applied to the surface coating before, after, and/or during the curing of the surface coating.

The coating composition may be applied directly to a substrate without any intermediate layers between the coating composition and the substrate. For example, the coating composition may be applied directly to a metal substrate, before or after the substrate is cleaned and/or treated as further described herein, but before application of any coating layers. The coating composition may also be applied during cleaning such as a component of the cleaner. The coating composition may be applied over the entire surface, edges, and corners of the substrate, or the coating composition may be applied over selected portions of the substrate.

In embodiments where a surface coating is used, the surface coating may be selectively applied over the edges and comers of the substrate so that the later applied coating composition only interacts with the surface coating over the edges and comers of the substrate.

The coating composition may also form a continuous or semi-continuous layer over the substrate, or the coating composition may be applied over certain spots/areas of the substrate such as the edges and comers of the substrate. As used herein, the area referred to as the “edge” will vary based on the particular substrate but may include, e.g., the outer most lateral face of the substrate.

Once applied, the coating composition may be physisorbed onto the substrate in which the coating composition is physically adsorbed over the substrate through intermolecular forces. Alternatively, the coating composition is chemisorbed onto the substrate in which the coating composition is chemically adsorbed over the substrate through valence forces or chemical bonding. For example, the coating composition may bond to the substrate through hydroxyl groups present on the substrate.

The coating composition may also be incorporated into a pretreatment composition that is applied over the substrate. As used herein, a “pretreatment composition” refers to a composition that reacts with and chemically alters the substrate surface achieving at least one of the following: 1) formation of a protective layer; 2) improved substrate topography or reactivity to enhance coating adhesion; or 3) formation of a protective layer with improved coating adhesion in comparison to the substrate without pretreatment. Non-limiting examples of pretreatment compositions include compositions that comprise iron phosphate, manganese phosphate, zinc phosphate, a rare earth metal, permanganate or manganese, molybdate or molybdenum, zirconium, titanium, hafnium, lanthanides, a silane such as an alkoxysilane, hydrolyzed silanes and silane oligomers and polymers, metal chelates, trivalent chrome (TCP), silicate, silica, phosphonic acids, chromate conversion coating, hydrotalcite, layered double hydroxide, metal oxides, other metals such as Group IV metals, or any combination thereof. Non-limiting examples of organic pretreatments may include chemically modified resins such as phosphatized epoxies, silanized epoxies and amino functional resins. The pretreatment may also include anodizing using, such as for example, sulfuric acid, nitric acid, hydrofluoric acid, tartaric acid, and other anodizing methods. The pretreatment composition may be in the form of a sol-gel, a liquid, or a solid. In some instances, a pretreatment may contain or be sealed using an oligomeric or polymeric solution or suspension. In yet other instances, a pretreatment composition may contain small organic molecules with reactive functionality or those which function as corrosion inhibitors.

When the pretreatment composition is applied to the substrate and cured or dried, a surface region of the pretreatment layer applied to the substrate may have a greater concentration of the coating composition than a bulk region of the layer applied to the substrate. For example, the surface tension of the coating composition may be lower than the surface tension of other components of the pretreatment composition. As a result, the coating composition migrates to the surface of the pretreatment layer (i.e., moves through the bulk region to the surface region) such that a greater concentration of the coating composition may be found in the surface region, while the remaining amount of the coating composition is dispersed throughout the bulk region.

As used herein, the “surface region” means the region that is generally parallel to the exposed air-surface of the coated substrate and which has thickness generally extending perpendicularly from the surface of the cured coating beneath the exposed surface. A “bulk region” of the cured composition means the region which extends beneath the surface region and which is generally parallel to the surface of the coated substrate.

The pretreatment composition that includes the coating composition may comprise greater than 0.05 weight %, greater than 0.1 weight %, greater than 1 weight %, less than 20 weight %, less than 15 weight %, less than 10 weight %, less than 8 weight %, less than 5 weight %, less than 3 weight % of the coating composition, or within any range including any two of these amounts as end points, based on the total weight of the pretreatment composition or may comprise any range using any two of the foregoing values as endpoints.

The coating composition can also be applied over at least a portion of a substrate that has already had a previous pretreatment and/or coating applied. For example, the coating composition can be applied to a previously deposited pretreatment layer. Non-limiting examples of pretreatment layers include layers formed from any of the previously described pretreatment compositions. The coating composition can also be applied over a primer layer or another previously applied coating layer.

One method for applying the coating composition to the substrate comprises dipping the substrate into a solution that contains the coating composition. The solution can be, for example, a pretreatment bath. As used herein, a “pretreatment bath” refers to a liquid bath containing the coating composition and that may optionally contain other components typically found in any type of pretreatment bath. Non-limiting examples of pretreatment baths that the coating composition can be incorporated into include a cleaner bath, a deoxidizer bath, a cleaner coater bath, a rinse conditioner bath, a pretreatment coating bath, a rinsing bath, a sealing bath, or a deionized water rinsing bath. It will be appreciated that the coating composition can be added to any commercially available pretreatment product. It will also be appreciated that when spray pretreatments are used, immersion steps may be avoided entirely.

A “cleaner bath” is a bath comprising materials for removing grease, dirt, or other extraneous matter from the substrate. Non-limiting examples of materials for cleaning the substrate include mild or strong alkaline cleaners.

A “deoxidizer bath” is a bath comprising materials for removing an oxide layer found on the surface of the substrate such as acid-based deoxidizers. Non-limiting examples of acid-based deoxidizers include phosphoric acid, citric acid, nitric acid, fluoroboric acid, sulfuric acid, chromic acid, hydrofluoric acid, and ammonium bifluoride.

A “cleaner-coater bath” is a bath comprising materials for both cleaning and coating the substrate in the same stage. The cleaner-coater bath can therefore clean the substrate, for example as with a mild or strong alkaline cleaner, and then coat the substrate, for example with a pretreatment coating as previously described, in a single step. A nonlimiting example of a cleaner-coater includes CHEMFOS 51HD, commercially available from PPG.

A “rinse conditioner bath” is a bath comprising activating agents for increasing the number of activation sites on the surface of the substrate for improved reaction with a pretreatment composition in order to enhance the protection of the substrate. Anon-limiting example of a rinse conditioner bath is a bath comprising activating agents that increase the number of sites on the surface of the substrate where phosphate crystals form upon application of a phosphate coating.

A “pretreatment coating bath” refers to a bath comprising a composition for forming a protective layer over the surface of the substrate. Non-limiting examples of pretreatment compositions include any of the pretreatment compositions previously described.

A “rinsing bath” is a bath comprising a solution of rinsing agents to remove any residue after application of a cleaner or pretreatment layer such as a phosphate containing pretreatment layer. In some non-limiting examples, a rinsing bath may simply contain city water or de-ionized water.

A “sealing bath” is a bath comprising a solution or dispersion that is capable of affecting a material deposited onto a substrate in such a way as to enhance its physical and/or chemical properties. Sealer compositions generally utilize solubilized metal ions and/or other inorganic materials to enhance the protection (e.g., corrosion protection) of pretreated substrates. Non-limiting examples include CHEMS EAL 59 and CHEMS EAL 100, both which are commercially available from PPG.

A “deionized water rinsing bath” is a bath that comprises deionized water and can be utilized in multiple stages of a pretreatment process such as a final rinsing stage before drying.

Other non-limiting examples of application methods that can be used to apply the coating composition onto the substrate include: spraying, such as by incorporating the coating composition into a liquid formulation and using spray equipment; wiping where the coating composition is contained on and/or in a wipe and manually or automatically wiped; media blasting where the coating composition is a solid and is blasted onto the substrate's surface; electrostatically applied as a powder; brushing or rolling the coating composition over the substrate such as by incorporating the coating composition into a formulation (e.g., liquid or gel) that can be brushed or rolled; vapor deposition; electrodeposition where the formulation is liquid and is electro-coated; or any combination thereof. The coating composition may also be applied in-mold, during extrusion, during a calendaring, or during other processing of substrate materials.

The previously described methods of applying the coating composition can also be used in the absence of binder components, aside from those that may already be present in the powder coating compositions herein. For example, the previously described baths can be substantially free, essentially free, or completely free of binder components that react to form a separate coating layer from the coating layer when cured. The term “substantially free” as used in this context means that the methods such as the baths use or contain less than 1000 parts per million (ppm), “essentially free” means less than 100 ppm, and “completely free” means less than 20 parts per billion (ppb) of binder components that react to form a separate coating layer from the coating layer when cured, based on the total weight of the components such as the components that form the baths.

The coating composition can be deposited onto the substrate by one or more of any of the previously described methods. The coating composition can also be applied alone or in combination with other treatments or coating processes. For example, the substrate of the present disclosure can be dipped or submerged into one or more of any of the previously described baths that include the coating composition during treatment of the substrate. For instance, the coating composition can be incorporated into: a cleaner bath to apply the coating composition directly over the surface substrate; a pretreatment coating bath to apply the coating composition over the substrate together with the pretreatment layer; or a final deionized water rinse to apply the coating composition over a pretreatment layer. In another non-limiting example, the substrate is sprayed or wiped with a solution that comprises the coating composition after application of a pretreatment layer or primer layer. In another non-limiting example, the coating composition may be present in more than one process step.

The substrate can undergo various treatments prior to application of the coating composition. For instance, the substrate can be alkaline cleaned, deoxidized, mechanically cleaned, ultrasonically cleaned, solvent wiped, roughened, plasma cleaned or etched, exposed to chemical vapor deposition, treated with an adhesion promoter, plated, anodized, annealed, cladded, or any combination thereof prior to application of the coating composition. The substrate can be treated using any of the previously described methods prior to application of the coating composition such as by dipping the substrate in a cleaner and/or deoxidizer bath prior to applying the coating composition. The substrate can also be plated prior to applying the coating composition. As used herein, “plating” refers to depositing a metal over a surface of the substrate. The substrate may also be 3D printed.

The coating composition can be applied to the substrate to which a surface coating or primer is applied without any intervening steps such as drying or heating steps. Alternatively, an additional process step(s) can be conducted before applying the coating composition including, but not limited to, drying by air and/or heating the coating composition. For example, a surface coating can be applied in a final deionized water rinse or in a pretreatment composition and then dried by air or heat before applying the coating composition. The coating composition and/or surface coating can also be applied to the substrate followed by a rinsing step.

The coating composition can be applied to the substrate to form a monocoat. As used herein, a “monocoat” refers to a single coating layer that is free of additional coating layers. Thus, the coating composition can be applied directly to a substrate and cured to form a single layer coating, i.e. a monocoat.

The coated substrate of the present disclosure may further comprise one or more additional coating layers, such as a second overcoat deposited onto at least a portion of the first coating compoistion, to form a multi-layer coating such as by applying a topcoat. When a multi-layer coating is formed, the first coating composition can be cured prior to application of additional overcoats, or one or more of the additional overcoats and the first coating composition can be cured simultaneously. It is appreciated that the second overcoat and/or additional overcoat can be in solid or liquid form.

The overall coating on the substrate may have a thickness of greater than 20 μm, greater than 30 μm, greater than 40 μm, less than 250 μm, less than 200 μm, less than 150 μm, or any range including any two of these amounts as endpoints. For example, the overall coating may have a thickness of 20 μm-250 μm, 30 μm-200 μm, or 40 μm-150 μm. The thickness may be measured using an Elcometer film gauge (model number SSSBC127-X) and averaged between three measurements.

### IV. Coated Substrate Properties

Substrates coated according to the present disclosure may have one or more improved properties and/or may address one or more issues known in the coating industry. The improved properties may be observed in comparison to other, previously known coating compositions. This may include, for example:

The cured coating layers may have a low gloss value as determined using a Micro Trigloss tester, measured at 60° C. in accordance with ASTM D523. The cured coated substrates may have a gloss value at 60° of less than 80, less than 75, less than 70, less than 65, less than 60, less than 55, less than 50, less than 45, less than 40, less than 35, less than 30, less than 25, less than 20, less than 15, less than 10, less than 5, or any range including any two of these values as endpoints. Furthermore, any given multi-component coating composition as described herein may be able to produce a range of gloss values depending on the curing conditions.

The powder coating compositions as described herein may also fully cure at relatively temperatures, as determined using differential scanning calorimetry (DSC) methods to measure the cure exotherm of a coating sample. For example, a DSC sample may be prepared, then held at a prescribed time and temperature (e.g., 10 minutes at 130° C.), followed by dropping the temperature to ambient, then ramping the temperature to 220° C. and checking for a cure exotherm curve in the 120-170° C. range depending on the formula. If an exotherm is observed, same indicates that the coating was not fully cured. Also, MEK rub testing according to ASTM D5402-19 may optionally be used as a method of showing a degree of curing, through the evaluation is subjective.

The present coating composition may be cured at less than 400° F., less than 375° F., less than 350° F., less than 325° F., less than 300° F., less than 290° F., less than 280° F., less than 275° F., less than 270° F. , less than 260° F. , less than 250° F., or any range including any two of these values as endpoints. Stated differently, the coating composition may be cured at less than 200° C., less than 190° C., less than 180° C., less than 170° C., less than 160° C., less than 150° C., less than 140° C., less than 130° C., less than 120° C., or any range including any two of these values as endpoints. For example, the coating composition may be cured at a temperature from 120° C. to 200° C., from 120° C. to 190° C., from 120° C. to 180° C., from 120° C. to 170° C., from 120° C. to 160° C., from 120° C. to 150° C., from 120° C. to 140° C., or from 120° C. to 130° C.

The powder coating composition may also cure relatively quickly. For example, the powder coating compositions may cure at a temperature as given above in less than 20 minutes, less than 15 minutes, less than 10 minutes, less than 9 minutes, less than 8 minutes, less than 7 minutes, less than 6 minutes, less than 5 minutes, less than 4 minutes, or any range including any two of these values as endpoints. For example, the curing time may be from 4 minutes to 20 minutes, from 4 minutes to 15 minutes, from 4 minutes to 10 minutes, from 4 minutes to 6 minutes, from 5 minutes to 15 minutes, from 5 minutes to 10 minutes, or from 4 minutes to 9 minutes.

The powder coating compositions as described herein may also provide a range of gloss values for a given composition depending on curing conditions (e.g. curing temperature, curing time, rate of temperature change, preheating the substrate, preheat temperature, applying electromagnetic radiation to the composition, etc.). Stated differently, altering the curing conditions for a coating composition may alter the finish or gloss value of a cured coating. For example, altering the curing conditions for a coating composition may alter the gloss value at 60° by at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, or any range including any two of these values as endpoints.

### EXAMPLES

Embodiments provided by the present disclosure are further illustrated by reference to the following examples, which describe methods of making coating systems and properties of coating systems. It will be apparent to those skilled in the art that many modifications, both to materials, and methods, may be practiced without departing from the scope of the disclosure.

### Experimental Methods

### Method 1—Gloss Value

The gloss value for each cured substrate was determined using a Micro Trigloss tester, measured at 60° C. in accordance with ASTM D523.

### Examples 1-3

### Single-Component Coating Composition

In these examples, three film-forming resins were used in combination with a crosslinker, a matting agent, a catalyst, and other additives to form a powder coating composition. The coating composition was not split into multiple components. The coating composition was then coated onto a metal substrate, cured, and the gloss value determined.

Examples 1 through 3 incorporated matting agent acrylic resin Joncryl 848 into an epoxy/dicyandiamide (dicy) cure. Each example was coated onto a metal substrate and cured for 9 minutes at 260° F. The results are summarized in Tables 1 and 2 below.

Note that in all of the following tables, EEW or EW refers to (epoxy) equivalent weight. Additionally, the Epoxy resins are considered to be “film forming resins”, the carboxyl functional acrylic resin is considered to be a “matting agent” and the adduct accelerator and/or hardener is considered to be a “catalyst” as such terms are used herein.

TABLE 1
Single-Component Coating Formulations

| | Example 1 | | Example 2 | | Example 3 | |
|---|---|---|---|---|---|---|
| | | Mass | | 300 g | | Mass |
| Compound/Function | Wt. % | (g) | Wt. % | resin | Wt. % | (g) |
| Solid Epoxy Resin EEW | 73.458 | 300.000 | 59.284 | 240.000 | 59.465 | 240.000 |
| 600-700, softening at | | | | | | |
| 75-85° C. | | | | | | |
| Solid Epoxy Resin EEW | 0.000 | 0.000 | 0.000 | 0.000 | 14.866 | 60.000 |
| 500-562, softening at | | | | | | |
| 75-85° C. | | | | | | |
| Solid Epoxy Resin EEW | 0.000 | 0.000 | 14.821 | 60.000 | 0.000 | 0.000 |
| 525-550, softening at | | | | | | |
| 70-75° C. | | | | | | |
| Dicyandiamide, crosslinker | 1.993 | 8.138 | 2.167 | 8.772 | 2.214 | 8.935 |
| for epoxy resin, EW = 40 | | | | | | |
| Carboxyl functional acrylic | 14.307 | 58.431 | 14.484 | 58.635 | 14.308 | 57.746 |
| resin, EW~261, softening | | | | | | |
| at 127° C., reacts with | | | | | | |
| epoxide groups for gloss | | | | | | |
| control | | | | | | |
| Imidazole-Bisphenol A | 7.300 | 29.812 | 6.175 | 25.000 | 6.194 | 25.000 |
| adduct accelerator and/or | | | | | | |
| hardener for epoxy/dicy | | | | | | |
| reaction | | | | | | |
| Acrylic flow agent for | 1.172 | 4.787 | 1.235 | 5.000 | 1.165 | 4.700 |
| powder coatings | | | | | | |
| Degassing agent for | 0.500 | 2.044 | 0.500 | 2.024 | 0.500 | 2.018 |
| powder coatings | | | | | | |
| Distearyl penterythritol | 0.488 | 1.995 | 0.494 | 2.000 | 0.496 | 2.000 |
| diphosphite antioxidant/ | | | | | | |
| heat stabilizer | | | | | | |
| Wax blend to improve | 0.781 | 3.191 | 0.840 | 3.400 | 0.793 | 3.200 |
| scratch/mar | | | | | | |
| | 100.00 | 408.398 | 100.0 | 404.831 | 100.0 | 403.599 |

TABLE 2
Gloss Values for Examples 1-3

| Example 1 | Example 2 | Example 3 |
|---|---|---|
| 75.2 | 73.5 | 70.9 |

The formulas in Examples 1-3 were sufficiently catalyzed to cure at relatively low temperatures, but at these low temperatures, the action of the matting agent was not observed. Examples 2 and 3 used a combination of epoxy resins to promote traditional deglossing from incompatibility, but the difference in gloss was minimal. The compositions were cured on a metal substrate.

### Examples 4 and 5

### Multi-Component Coating Composition

In these examples, a multi-component coating composition is prepared. Component A comprised a first film forming resin and a crosslinker, and Component B comprised a second film forming resin and a matting agent. Both components comprised a catalyst and other additives. The coatings were coated onto a metal substrate, cured, and the gloss value determined.

Parts A and B were blended together in a 52/48 blend respectively based on the weight of each component. Each example was coated onto a metal substrate and cured for 9 minutes at 260° F. The results are summarized in Tables 3-5 below.

TABLE 3
Multi-Component Coating Composition Formulation (Example 4)

| | Part B | | Part A | | 48/52 Blend | |
|---|---|---|---|---|---|---|
| | | Mass | | Mass | | Mass |
| Compound/Function | Wt. % | (g) | Wt. % | (g) | Wt. % | (g) |
| Solid Epoxy Resin EEW | 0.000 | 0.000 | 86.118 | 300.000 | 44.781 | 180.408 |
| 600-700, softening at | | | | | | |
| 75-85° C. | | | | | | |
| Solid Epoxy Resin EEW | 61.845 | 300.000 | 0 | 0.000 | 29.686 | 119.592 |
| 500-562, softening at | | | | | | |
| 75-85° C. | | | | | | |
| Dicyandiamide, crosslinker for | 0.000 | 0.000 | 4.536 | 15.802 | 2.359 | 9.502 |
| epoxy resin, EW = 40 | | | | | | |
| Carboxyl functional acrylic | 30.398 | 147.456 | 0 | 0.000 | 14.591 | 58.782 |
| resin, EW~261, softening at | | | | | | |
| 127° C., reacts with epoxide | | | | | | |
| groups for gloss control | | | | | | |
| Imidazole-Bisphenol A adduct | 5.154 | 25.001 | 6.028 | 20.999 | 5.608 | 22.594 |
| accelerator and/or hardener for | | | | | | |
| epoxy/dicy reaction | | | | | | |
| Acrylic flow agent for powder | 1.031 | 5.001 | 1.353 | 4.713 | 1.198 | 4.828 |
| coatings | | | | | | |
| Degassing agent for powder | 0.500 | 2.425 | 0.5 | 1.742 | 0.500 | 2.014 |
| coatings | | | | | | |
| Distearyl penterythritol | 0.412 | 1.999 | 0.564 | 1.965 | 0.491 | 1.978 |
| diphosphite antioxidant/ heat | | | | | | |
| stabilizer | | | | | | |
| Wax blend to improve | 0.660 | 3.202 | 0.901 | 3.139 | 0.785 | 3.164 |
| scratch/mar | | | | | | |
| Total | 100.000 | 485.084 | 100.00 | 348.359 | 100.000 | 402.863 |

TABLE 4
Multi-Component Coating Composition Formulation (Example 5)

| | Part B | | Part A | | 48/52 Blend | |
|---|---|---|---|---|---|---|
| | | Mass | | Mass | | Mass |
| Compound/Function | Wt. % | (g) | Wt. % | (g) | Wt. % | (g) |
| Solid Epoxy Resin EEW | 0.000 | 0.000 | 85.133 | 296.569 | 44.269 | 178.344 |
| 600-700, softening at | | | | | | |
| 75-85° C. | | | | | | |
| Solid Epoxy Resin EEW | 61.845 | 300.000 | 0 | 0.000 | 29.686 | 119.592 |
| 500-562, softening at | | | | | | |
| 75-85° C. | | | | | | |
| Dicyandiamide, crosslinker for | 0.000 | 0.000 | 4.485 | 15.624 | 2.332 | 9.396 |
| epoxy resin, EW = 40 | | | | | | |
| Carboxyl functional acrylic | 30.398 | 147.456 | 0 | 0.000 | 14.591 | 58.782 |
| resin, EW~261, softening at | | | | | | |
| 127° C., reacts with epoxide | | | | | | |
| groups for gloss control | | | | | | |
| Imidazole-Bisphenol A adduct | 5.154 | 25.001 | 7.095 | 24.716 | 6.163 | 24.830 |
| accelerator and/or hardener for | | | | | | |
| epoxy/dicy reaction | | | | | | |
| Acrylic flow agent for powder | 1.031 | 5.001 | 1.338 | 4.661 | 1.191 | 4.797 |
| coatings | | | | | | |
| Degassing agent for powder | 0.500 | 2.425 | 0.5 | 1.742 | 0.500 | 2.014 |
| coatings | | | | | | |
| Distearyl penterythritol | 0.412 | 1.999 | 0.557 | 1.940 | 0.487 | 1.964 |
| diphosphite antioxidant/ heat | | | | | | |
| stabilizer | | | | | | |
| Wax blend to improve | 0.660 | 3.202 | 0.892 | 3.107 | 0.781 | 3.145 |
| scratch/mar | | | | | | |
| Total | 100.000 | 485.084 | 100.00 | 348.359 | 100.000 | 402.863 |

TABLE 5
Gloss Values for Examples 4 and 5

| Example 4 | Example 5 |
|---|---|
| 52.1 | 58.2 |

In both examples 4 and 5, the blend of powders achieves a significantly lower gloss using the same curing schedule and substrate when compared to Examples 1-3. In example 4, Part A is catalyzed slightly less than Part A in example 5, and gloss at this slightly slower rate is slightly lower.

### Example 6

### Multi-Component Coating Composition with Liquid Epoxy Resin

In these examples, a multi-component coating composition is prepared similar to example 4, but with the use of a liquid epoxy resin in Component B. The coating was coated onto a metal substrate, cured, and the gloss value determined. The use of liquid epoxy in component B may result in using less of component B in the overall coating composition. Since component B, which comprises the matting agent, may cure more slowly than component A, use of less component B may result in shorter curing times. The coating composition was prepared by blending parts A and B together in a weight ratio of 61/39 respectively. The coating composition was then coated onto various substrates and cured with varying conditions, as will be described below. The formulation of Example 6 is summarized in Table 6 below.

TABLE 6
Multi-Component Coating Composition Formulation (Example 6)

| | Part B | | Part A | | 39/61 Blend | |
|---|---|---|---|---|---|---|
| | | Mass | | Mass | | Mass |
| Compound/Function | Wt. % | (g) | Wt. % | (g) | Wt. % | (g) |
| Solid Epoxy Resin EEW | 0.000 | 0.000 | 86.118 | 300.000 | 52.532 | 212.391 |
| 600-700, softening at | | | | | | |
| 75-85° C. | | | | | | |
| Liquid Epoxy Resin EEW | 11.112 | 60.000 | 0 | 0.000 | 4.334 | 17.522 |
| 186-190 | | | | | | |
| Solid Epoxy Resin EEW | 44.449 | 240.000 | 0 | 0.000 | 17.335 | 70.087 |
| 500-562, softening at | | | | | | |
| 75-85° C. | | | | | | |
| Dicyandiamide, crosslinker for | 0.000 | 0.000 | 4.536 | 15.802 | 2.767 | 11.187 |
| epoxy resin, EW = 40 | | | | | | |
| Carboxyl functional acrylic | 37.194 | 200.828 | 0 | 0.000 | 14.506 | 58.647 |
| resin, EW~261, softening at | | | | | | |
| 127° C., reacts with epoxide | | | | | | |
| groups for gloss control | | | | | | |
| Imidazole-Bisphenol A adduct | 4.630 | 25.000 | 6.028 | 20.999 | 5.483 | 22.167 |
| accelerator and/or hardener for | | | | | | |
| epoxy/dicy reaction | | | | | | |
| Acrylic flow agent for powder | 1.037 | 5.599 | 1.353 | 4.713 | 1.230 | 4.972 |
| coatings | | | | | | |
| Degassing agent for powder | 0.500 | 2.700 | 0.5 | 1.742 | 0.500 | 2.022 |
| coatings | | | | | | |
| Distearyl penterythritol | 0.415 | 2.241 | 0.564 | 1.965 | 0.506 | 2.045 |
| diphosphite antioxidant/ heat | | | | | | |
| stabilizer | | | | | | |
| Wax blend to improve | 0.663 | 3.580 | 0.901 | 3.139 | 0.808 | 3.268 |
| scratch/mar | | | | | | |
| Total | 100.000 | 539.947 | 100.00 | 348.359 | 100.000 | 404.307 |

The coating composition prepared in Example 6 was then coated onto a metal substrate and cured for 9 minutes at 260° F. The coating composition was also coated onto ½″ plywood, cured under IR for 2 minutes at 140 V in one example and at 200 V in another example, then both examples were cured for 6 minutes in a convection oven at 300° F.

In another set of curing examples, the coating composition was coated onto ¾″ medium density fiberboard (MDF). The coated MDF was preheated to varying board surface temperatures (BST) before applying the coating. Once applied, the coating was cured for 5 minutes at 300° F. For each curing method/set of conditions, the 60° gloss value was measured. The results are summarized in Table 7 below.

TABLE 7
Gloss Values for Example 6 Coating Composition
with Varying Curing Conditions

| | | | Heat | Heat | | |
|---|---|---|---|---|---|---|
| | IR | Preheated | Curing | Curing | Final | |
| | Voltage | BST | Temp | Time | BST | Gloss |
| Substrate | (V) | (° F.) | (° F.) | (Min) | (° F.) | Value |
| Metal | N/A | N/A | 260 | 9 | N/A | 47.2 |
| Plywood | 140 | N/A | 300 | 6 | N/A | 37.0 |
| Plywood | 200 | N/A | 300 | 6 | N/A | 14.1 |
| MDF | N/A | 210 | 300 | 5 | 240 | 48.9 |
| MDF | N/A | 251 | 300 | 5 | 251 | 37.2 |
| MDF | N/A | 272 | 300 | 5 | 272 | 29.1 |
| MDF | N/A | 290 | 300 | 5 | 290 | 23.5 |

It should be noted that boards that ramped more quickly to temperature, and boards that were baked to higher temperatures were lower in gloss. It should also be noted that all said boards were conventionally cured enough that they have adequate film properties, regardless of gloss level.

### Examples 7 and 8

### Multi-Component Coating Composition with White pigment

In these examples, a multi-component coating composition is prepared similar to Example 6, but with a white pigment instead of a clear pigment, and with a slightly different matting agent (Jonacryl 848). The coatings were coated onto a metal substrate, cured, and the gloss value determined. Example 7 uses a liquid epoxy similar to Example 6, and Example 8 does not use liquid epoxy, similar to Examples 4 and 5. Coatings for Examples 7 and 8 were applied to a preheated, ¾″ MDF and cured for 5 minutes at varying temperatures. The formulations are summarized in Tables 8 and 9 below, and the gloss values summarized in Table 10.

TABLE 8
Multi-Component Coating Composition Formulation (Example 7)

| | Part B | | Part A | | 39/61 Blend | |
|---|---|---|---|---|---|---|
| | | Mass | | Mass | | Mass |
| Compound/Function | Wt. % | (g) | Wt. % | (g) | Wt. % | (g) |
| Solid Epoxy Resin EEW | 0.000 | 0.000 | 70.661 | 300.000 | 35.331 | 183.933 |
| 600-700, softening at | | | | | | |
| 75-85° C. | | | | | | |
| Liquid Epoxy Resin EEW | 8.918 | 60.034 | 0.000 | 0.000 | 4.459 | 23.214 |
| 186-190 | | | | | | |
| Solid Epoxy Resin EEW | 35.671 | 240.128 | 0.000 | 0.000 | 17.836 | 92.853 |
| 500-562, softening at | | | | | | |
| 75-85° C. | | | | | | |
| Dicyandiamide, crosslinker for | 0.000 | 0.000 | 3.723 | 15.806 | 1.862 | 9.691 |
| epoxy resin, EW = 40 | | | | | | |
| Carboxyl functional acrylic | 31.449 | 211.706 | 0.000 | 0.000 | 15.725 | 81.863 |
| resin, EW~261, softening at | | | | | | |
| 127° C., reacts with epoxide | | | | | | |
| groups for gloss control | | | | | | |
| Imidazole-Bisphenol A adduct | 3.715 | 25.008 | 4.948 | 21.007 | 4.332 | 22.550 |
| accelerator and/or hardener for | | | | | | |
| epoxy/dicy reaction | | | | | | |
| Acrylic flow agent for powder | 1.037 | 6.981 | 1.125 | 4.776 | 1.081 | 5.628 |
| coatings | | | | | | |
| Degassing agent for powder | 0.411 | 2.767 | 0.410 | 1.741 | 0.411 | 2.137 |
| coatings | | | | | | |
| Distearyl penterythritol | 0.415 | 2.794 | 0.469 | 1.991 | 0.442 | 2.301 |
| diphosphite antioxidant/ heat | | | | | | |
| stabilizer | | | | | | |
| Wax blend to improve | 0.663 | 4.463 | 0.750 | 3.184 | 0.707 | 3.678 |
| scratch/mar | | | | | | |
| TiO2 PW6 | 17.714 | 119.246 | 17.907 | 76.026 | 17.811 | 92.723 |
| Phthalo Blue PB 15 | 0.001 | 0.007 | 0.001 | 0.004 | 0.001 | 0.005 |
| Quinacridone Red PV19 | 0.006 | 0.040 | 0.006 | 0.025 | 0.006 | 0.031 |
| Total | 100.000 | 673.174 | 100.00 | 424.562 | 100.000 | 520.607 |

TABLE 9
Multi-Component Coating Composition Formulation (Example 8)

| | Part B | | Part A | | 39/61 Blend | |
|---|---|---|---|---|---|---|
| | | Mass | | Mass | | Mass |
| Compound/Function | Wt. % | (g) | Wt. % | (g) | Wt. % | (g) |
| Solid Epoxy Resin EEW | 0.000 | 0.000 | 70.661 | 300.000 | 27.558 | 142.681 |
| 600-700, softening at | | | | | | |
| 75-85° C. | | | | | | |
| Liquid Epoxy Resin EEW | 0.000 | 0.000 | 0.000 | 0.000 | 0.000 | 0.000 |
| 186-190 | | | | | | |
| Solid Epoxy Resin EEW | 49.811 | 300.000 | 0.000 | 0.000 | 30.385 | 157.317 |
| 500-562, softening at | | | | | | |
| 75-85° C. | | | | | | |
| Dicyandiamide, crosslinker for | 0.000 | 0.000 | 3.723 | 15.806 | 1.452 | 7.518 |
| epoxy resin, EW = 40 | | | | | | |
| Carboxyl functional acrylic | 25.798 | 155.375 | 0.000 | 0.000 | 15.737 | 81.477 |
| resin, EW~261, softening at | | | | | | |
| 127° C., reacts with epoxide | | | | | | |
| groups for gloss control | | | | | | |
| Imidazole-Bisphenol A adduct | 4.155 | 25.025 | 4.948 | 21.007 | 4.464 | 23.114 |
| accelerator and/or hardener for | | | | | | |
| epoxy/dicy reaction | | | | | | |
| Acrylic flow agent for powder | 1.031 | 6.209 | 1.125 | 4.776 | 1.068 | 5.528 |
| coatings | | | | | | |
| Degassing agent for powder | 0.411 | 2.475 | 0.410 | 1.741 | 0.411 | 2.126 |
| coatings | | | | | | |
| Distearyl penterythritol | 0.413 | 2.487 | 0.469 | 1.991 | 0.435 | 2.251 |
| diphosphite antioxidant/ heat | | | | | | |
| stabilizer | | | | | | |
| Wax blend to improve | 0.660 | 3.975 | 0.750 | 3.184 | 0.695 | 3.599 |
| scratch/mar | | | | | | |
| TiO2 PW6 | 17.714 | 106.687 | 17.907 | 76.026 | 17.789 | 92.104 |
| Phthalo Blue PB 15 | 0.001 | 0.006 | 0.001 | 0.004 | 0.001 | 0.005 |
| Quinacridone Red PV19 | 0.006 | 0.036 | 0.006 | 0.025 | 0.006 | 0.031 |
| Total | 100.000 | 602.277 | 100.00 | 424.562 | 100.000 | 517.750 |

TABLE 10
Gloss Values for Examples 7 and 8 Coating Composition with Varying
Curing Conditions on MDF

| | Preheated | Heat Curing | Heat Curing | Final | Gloss |
|---|---|---|---|---|---|
| Example | BST (° F) | Temp (° F) | Time (Min) | BST (° F) | Value |
| 7 | 257 | 325 | 5 | 270 | 12.6 |
| 7 | 275 | 350 | 5 | 290 | 12.5 |
| 8 | 255 | 325 | 5 | 266 | 21.5 |
| 8 | 266 | 350 | 5 | 285 | 17.9 |

Reviewing the above data, blended multi-component coating systems appear to give lower gloss than creating a similar formula in a single powder, and furthermore gives gloss control depending on the rate of heating of the powder coated substrate and the composition of the coting composition. The matting agent(s) used here have significantly higher softening points than the epoxy resins they are intended to react with. Without wishing to be bound to theory, the present inventors believe that the epoxy/dicy reaction is highly catalyzed, and reaction can start as low as 220 F. If the heating of the coated part is slow enough, then the film can set-up and cure prior to the matting agent becoming sufficiently soft to act as a matting agent. While heating the powder coated part more quickly will understandably cause a faster cure-time, it appears to give the film enough mobility while still hot enough for the matting agent to matte the surface. While this could be considered problematic with metal substrates that have varying thicknesses (thick portions would heat up slower than thin), the wood substrates this coating is intended for are often relatively flat.

Whereas particular examples of this invention have been described above for purposes of illustration, it will be evident to those skilled in the art that numerous variations of the details of the present invention may be made without departing from the invention as defined in the appended claims.

1. A powder coating system, comprising:
a first component (A), comprising:
a first film forming resin; and
a crosslinker; and
a second component (B), comprising:
a second film forming resin; and
a matting agent;
wherein at least one of the components (A) and (B) additionally comprises a catalyst present in an amount of at least 3 wt. % based on the total weight of the respective component.

2. The powder coating system of claim 1, wherein at least one of the first film forming resin and the second film forming resin comprises an epoxy resin.

3. The powder coating system of claim 1, wherein the second film forming resin comprises a liquid epoxy resin.

4. The powder coating system of claim 1, wherein components (A) and (B) are present in a weight ratio of X:Y respectively, wherein X and Y are independently from 1 to 3.

5. The powder coating system of claim 1, wherein each of the first film forming resin and the second film forming resin are independently present in an amount of at least 4 wt. % based on the total weight of the powder coating system.

6. The powder coating system of claim 5, wherein the first film forming resin is present in an amount from 30 wt. % to 60 wt. % and the second film forming resin is present in an amount from 4 wt. % to 40 wt. % based on the total weight of the powder coating system.

7. The powder coating system of claim 1, wherein at least one of components (A) and (B) further comprises at least one of a flow agent, a degassing agent, a heat stabilizer, and a wax.

8. The powder coating system of claim 1, wherein the matting agent has a higher softening temperature, as determined by differential scanning calorimetry (DSC), than the first film forming resin and the second film forming resin.

9. The powder coating system of claim 1, wherein the powder coating system is fully cured at a temperature of less than 150° C. (302° F.) and a time of less than 10 minutes.

10. The powder coating system of claim 9, wherein the cured powder coating system has a gloss value at 60° of less than 60 in accordance with ASTM D 523.

11. The powder coating system of claim 1, wherein the matting agent is present in component (B) in an amount from 10 wt. % to 50 wt. % based on the weight of component (B), and the matting agent is present in component (A) in an amount less than 0.01 wt. % based on the weight of component (A), or component (A) is substantially free of a matting agent.

12. The powder coating system of claim 1 wherein the matting agent comprises an acid functional acrylic resin.

13. A method of coating a substrate comprising:
contacting a first component (A) with a second component (B) to form a coating composition, wherein component (A) comprises a first film forming resin and a crosslinker, and component (B) comprises a second film forming resin and a matting agent;
applying the coating composition to a substrate; and
heating the coating composition on the substrate at a temperature of less than 130° C. (266° F.) for less than 10 minutes to form a cured coating.

14. The method of claim 13, wherein the applying step comprises electrospray coating.

15. The method of claim 13, wherein the cured coating has a gloss value of less than 60.

16. The method of claim 13, further comprising the step of exposing the coating system to infrared radiation at a voltage for a time from 1 to 5 minutes.

17. The method of claim 13, further comprising the step of preheating the substrate to a surface temperature of at least 80° C. (176° F.) before the applying step.

18. The method of claim 13, wherein the substrate is selected from the group consisting of: a metal, a wood, a polymer, and a composite thereof.

19. The method of claim 13, wherein the first film forming resin and the second film forming resin each comprise an epoxy resin, and the matting agent comprises a carboxyl functional acrylic resin.

20. A powder coating system comprising:
a first component (A) comprising a first film forming resin and a crosslinker; and
a second component (B) comprising a second film forming resin and a matting agent;
wherein the second film forming resin is present in an amount greater than 4 wt. % based on the total weight of the powder coating system.

21. The powder coating system of claim 20, further comprising at least one of a flow agent, a catalyst, a heat stabilizer, a degassing agent, and a wax.

22. The powder coating system of claim 20, wherein the second film forming resin comprises a liquid epoxy resin.

23. A substrate coated with the powder coating system claim 1.

24. A substrate coating with the power coating system of claim 20.
